(19) United States
(12) Patent Application Publication
(10) Pub. No.: US 2013/0291787 A1
(43) Pub. Date: Nov. 7, 2013

(54) Illuminated Emergency Notification Balloon

(71) Applicant: Gene P. Broussard, Jr., Jeanerette, LA (US)

(72) Inventor: Gene P. Broussard, Jr., Jeanerette, LA (US)

(21) Appl. No.: 13/869,396

(22) Filed: Apr. 24, 2013

Related U.S. Application Data
(60) Provisional application No. 61/641,528, filed on May 2, 2012.

(51) Int. Cl. B64B 1/50

(52) U.S. Cl. CPC B64B 1/50
USPC 116/201; 116/210

(57) ABSTRACT

Disclosed is an emergency notification device comprised of an inflatable balloon with an attached receiver, a reel containing a tethering string, a tank containing a lighter-than-air-gas for filling the balloon, and a balloon filling adapter. The balloon can be inflated and elevated to a height in order to make the location of the lost or injured person more conspicuous. A user can thread the tank into the adapter, attach the adapter to the receiver, and fill the balloon with a sufficient amount of lighter-than-air gas to achieve buoyancy. The device further includes an anchor strap for securing the balloon to the ground, and an illumination means that illuminates the entire balloon for increased visibility in lowlight or dark conditions.

### CROSS REFERENCE TO RELATED APPLICATION

This application claims the benefit of U.S. Provisional Application No. 61/641,528 filed on May 2, 2012 entitled “Help Balloon.” The above identified patent application is herein incorporated by reference in its entirety to provide continuity of disclosure.

### BACKGROUND OF THE INVENTION

1. Field of the Invention

The present invention relates to an emergency notification device. More specifically, it pertains to an illuminated emergency notification balloon that can be inflated and elevated to a height in order to make the location of the lost or injured person more conspicuous.

Many people enjoy spending time outdoors exploring remote areas. Activities such as camping, climbing, paddling and mountain biking may require participants to travel to a variety of remote locations to enjoy their hobby. Such pursuits, however, require preparation to ensure that the activity is safe and that the potential for injury is minimized. One way to prepare is to ensure that participants have a proper supply of gear for a given activity. In the 1930s, The Mountaineers, which is a Seattle-based organization for climbers and outdoor adventurers created a list that has become known as the ten essentials. The list consists of survival items that are recommended for safe travel in the backcountry. The list includes: 1) map, 2) compass, 3) sunglasses and sunscreen, 4) extra clothing, 5) flashlight, 6) first-aid supplies, 7) fire starter, 8) matches, 9) knife, and 10) extra food. While not every trip into the outdoors will require the use of the ten essentials, carrying these basic items improves the chances that one is prepared for an unexpected emergency in the outdoors.

While the ten essentials are designed to keep a user safe and alive while in the outdoors, the list does not include items for assisting a user who is lost or injured to be located. Many outdoor adventurists carry electronic communication devices, such as cell phones and global positioning systems (GPS) when traveling in the outdoors. These devices, however, require power and reception in order to work. As can be appreciated, conventional wireless communication devices, such as cellular phones, require a cell site to create a network connection for placing a phone call. Many backcountry activities, such as those that are in remote locations, take hobbyists to areas that do not have cell sites or network coverage, meaning that a phone call cannot be placed. In addition, phones and GPS devices require a power source for use. Modern devices are powered by batteries, which require recharging or replacement after a period of use. If users do not have a means of charging batteries or a replacement, their devices will cease functioning once the battery has been used.

If a person becomes lost or injured in the backcountry, and does not have a functioning electronic communication device, he or she must create a signal to notify others of his or her location and the need for assistance. This can be particularly difficult if one is injured and unable to gather materials to create a signal. In such situations, the person must wait for help to locate his or her position. If this occurs at night, the odds of being located drop significantly. The present invention provides a device that can be used day or at night as a locating and signaling device for a lost or injured person.

2. Description of the Prior Art

Devices have been disclosed in the prior art that relate to locating and signaling devices. These include devices that have been patented and published in patent application publications. These devices generally relate to emergency notification balloons. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 6,523,778 to Key discloses a process for creating a flying light source including the steps of providing an inflatable balloon and associating a light source therewith. A retaining filament is attached to the inflated balloon. The light source may be a chemiluminescent lighting device which is attached to, or inserted into the balloon. Alternatively, the light source may be a battery-operated light assembly attached to the balloon. The invention may be in the form of a rescue kit including the inflatable balloon, the chemiluminescent lighting device, the retaining filament and a lighter-than-air gas source. Alternatively, the invention may be in the form of a self-contained signaling device including a canister of lighter-than-air gas, a nozzle for dispensing the gas, the battery-operated light assembly, and the filament. While the Key device discloses an emergency balloon with a light assembly attached thereto, the structure and function of the device differ significantly from the present invention. The Key device includes an illumination means that is attached to the exterior of the balloon. The present invention provides a receiver containing an illumination means housed on the interior of the balloon which can illuminate the entire balloon for increased visibility at night, and includes indicia printed thereon that are outlined with a dark color to provide additional contrast for viewing at night.

U.S. Published Patent Application Publication No. 2010/0170431 to Lin discloses an air-floating device for rescue, comprising a portable case divided into several compartments, a gas bottle containing a gas lighter than the air, a reel having an appropriate length of string, balloons, and ribbons of different colors. When a disaster or disorientation occurs during an activity, the balloon is filled with the gas from the gas bottle and tied with the ribbon and string at the mouth. It is then allowed to float high above to make a conspicuous mark for the rescue team. The Lin device, however, does not disclose a filling adapter, receiver, or illumination means for locating the lost or injured person at night.

Similar to the Lin device, U.S. Pat. No. 6,164,239 to Dawson discloses a location identification balloon system for use by lost or injured hikers that includes a balloon filled with helium that is secured with a tether, and is allowed to float above the tree level to allow a search plane or helicopter to readily locate the missing person. The balloon has a number of air capturing pockets that cause the balloon to spin in the wind. The balloon and tether are attached by a swivel to allow the balloon to spin freely. The balloon is filled by pulling on a spool driven compression mechanism to cause a compression plate to compress the sealed tip end of a pressurized helium canister over the piercing tube end of a valve. While the '239 patent includes air capturing pockets to cause the balloon to spin, it does not, however, include lights on the interior of the balloon for use lowlight or dark conditions.

U.S. Pat. No. 5,582,127 to Willis discloses a method and device for marking an individual's location to facilitate rescue. The method comprises the step of removing a cover member or cap of the device which contains an inflatable balloon to open a valve of a cylinder containing a pressurized, lighter than air gas which inflates a balloon, so that the balloon rises in the atmosphere. The balloon is tied to one end of a line that has another end attached to the device. The balloon travels upward a distance essentially equal to the length of the line, hovering overhead to identify the individual's location. Similar to Dawson, the Willis device is not adapted for use in lowlight or dark conditions.

U.S. Pat. No. 6,359,568 to Johnson discloses a rescue device including a casing having a hollow interior area. The casing includes an opened top and enclosed bottom. Located within the casing is a gas cylinder, having a gas that is lighter than air. This gas cylinder is coupled to a collapsible and inflatable balloon. A sensing mechanism is coupled to a valve. This valve is coupled to the gas cylinder. Once a change in the electrical potential is detected via the sensing mechanism, it triggers the valve. This will cause the valve to open for the gas to enter and fill the balloon. During the inflation process, the balloon expands and inherently causes the top to be lifted and remove for allowing the balloon to float and travel upwards. The balloon is maintained to the device via a tether. The Johnson device, while disclosing a rescue device utilizing a balloon, does not disclose the structure of the present invention. The present invention provides a manually operated valve for inflation of the balloon, and does not utilize a sensing mechanism for detecting a change in electric potential. In addition, the Johnson device does not disclose an illumination means for viewing the balloon in lowlight or dark conditions.

U.S. Pat. No. 7,886,682 to Germain discloses a multifunctional emergency kit that includes a portable canister with an open top end and a lid. A helium cartridge is anchored within the canister, and a mechanism is included for automatically initiating a balloon while the lid is initially disposed at a closed position such that the balloon articulates the lid to an open position when filled to a predetermined volume. The kit further includes a plurality of illuminable sticks that glow in the dark when agitated. While the Germain device discloses a balloon and a plurality of illuminable sticks, the sticks are not attached to a receiver in order to illuminate the interior of the balloon.

U.S. Pat. No. 5,005,513 to Van Patten discloses a balloon signaling system which includes a hollow flexible flask having a reactable material which when contacted by a certain solution, produces hydrogen gas. Also included are an inflatable balloon and a one-way valve for allowing hydrogen gas to enter the balloon. A tube connects the opening of the flask to the valve to carry hydrogen gas from the flask to the balloon to inflate the balloon. The other end of the string is attached to the balloon. The '513 device utilizes a flask for creating hydrogen gas from a chemical reaction, and does not include a canister containing a lighter than air gas for inflation of the balloon. In addition, the device does not disclose a means of illuminating the balloon.

The devices disclosed in the prior art provide rescue balloons that help to determine the location of a lost or injured person. The primary function of such devices is to float at a height in order to improve visibility of the person. While some of these devices disclose a balloon containing an illumination means, none of these prior art devices utilize an illumination means that is disposed within the balloon. The light attached to the balloon receiver illuminates the entire balloon, as opposed to attaching a light to the outside thereof, which helps to improve visibility. In addition, the present invention provides a novel means of inflating the balloon, by utilizing an adapter that includes a spring-loaded puncture valve on a first end, a male quick connect fitting with a check valve on a second end, and a receiver that prevents the need for tying the balloon after it is filled with gas. This is particularly beneficial for use in cold conditions, where a user may struggle with creating a knot in the balloon to contain the gas therein.

In light of the prior art and the disclosed elements of the present invention, it is submitted that the present invention substantially diverges in design elements from the prior art. Consequently, it is clear that the present invention is not described by the art and that a need exists for an improved illuminated emergency notification balloon. In this regard, the instant invention substantially fulfills these needs.

### SUMMARY OF THE INVENTION

In view of the foregoing disadvantages inherent in the known types of emergency notification balloons now present in the prior art, the present invention provides a new emergency notification balloon wherein the same can be utilized for providing convenience for the user when locating a lost or injured person in lowlight or dark condition.

It is therefore an object of the present invention to provide a new and improved emergency notification balloon device that has all of the advantages of the prior art and none of the disadvantages.

It is another object of the present invention to provide a new and improved emergency notification balloon that provides a means of identifying a lost or injured person.

Another object of the present invention is to provide a new and improved emergency notification balloon that is filled with a lighter than air gas for floating the balloon to a height that makes the location of the lost or injured person more conspicuous.

Yet another object of the present invention is to provide a new and improved emergency notification balloon that includes a reel containing a tethering string for controlling the height of the balloon.

Another object of the present invention is to provide a new and improved emergency notification balloon that includes an adapter with a spring-loaded puncture valve on a first end, a male quick connect fitting with a check valve on a second end, and a receiver that prevents the need for tying the balloon after it is filled with gas.

Another object of the present invention is to provide a new and improved emergency notification balloon that includes an illumination means that is conventionally disposed within a receiver, and is used to illuminate the entire balloon for increasing visibility in lowlight or dark conditions.

Still another object of the present invention is to provide a new and improved emergency notification balloon that includes an anchor strap for securing the tethering string in position.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the present invention, including the inflatable balloon with an attached receiver, a reel containing a tethering string, a tank containing a lighter-than-air gas, and balloon filling adapter.

FIG. 2 shows a view of the tank, balloon filling adapter and balloon filling receiver filling the balloon with a lighter-than-air gas.

FIG. 3 shows a perspective view of the receiver, with an illumination means and carabineer attached thereto.

FIG. 4 shows a pictorial view of the present invention in use, with the balloon in an inflated state, and the illumination means active.

### DETAILED DESCRIPTION OF THE INVENTION

Reference is made herein to the attached drawings. Like reference numerals are used throughout the drawings to depict like or similar elements of the illuminated emergency notification balloon. For the purposes of presenting a brief and clear description of the present invention, the preferred embodiment will be discussed as used for providing a means of locating a lost or injured person. The figures are intended for representative purposes only and should not be considered to be limiting in any respect.

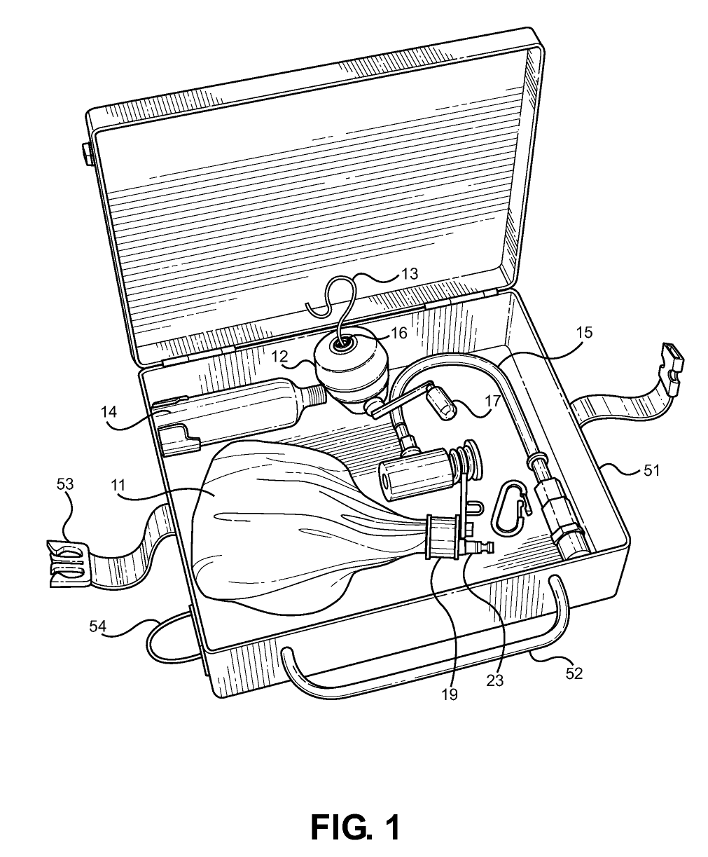

Referring now to FIG. 1, there is shown a view of the present invention, which comprises a system for rescuing a lost or injured person. The system includes an inflatable balloon 11 with an attached receiver 19, a reel 12 containing a tethering string 13, a tank 14 containing a lighter-than-air gas for filling the balloon 11, and a balloon filling adapter 15. The balloon 11 further includes an illumination means for increased visibility in lowlight or dark conditions. In an emergency situation, a user activates the illumination means, attaches the tank 14 and receiver 19 to the balloon filling adapter 15, and inflates the balloon 11. The string 13 within the reel 12 is attached to the balloon 11 and released, which enables the balloon 11 to rise up to a height where it can be used to alert those nearby that someone is in need of assistance.

The components of the present invention are contained within a case 51, which can be used for storage and transport. The case 51 further includes a carrying handle 52, and a strap 53. The strap 53 can be secured around the case 51 to prevent the device from inadvertently opening during transport. In addition, the exterior of the case 51 includes an attachment means for the tethering string 13. In the preferred embodiment, the attachment means comprises a D-ring 54 on the side of the case 51. The D-ring 54 enables the string 13 to be attached thereto for hands-free use of the balloon 11.

The balloon 11 comprises an inflatable, flexible bag for holding a lighter-than-air gas, which provides the balloon 11 with a sufficient amount of buoyancy to float. The balloon 11 can be constructed from a variety of materials, including rubber, latex, polychloroprene, nylon fabric, or another suitable material. The balloon 11 is preferably constructed of a material that slows the rate of effusion, which allows the device to remain aloft for an extended period of time. The balloon 11 can further be constructed in a variety of shapes and sizes that allow the balloon 11, receiver 19, and tethering string 13 to elevate to a desired height. Attached to the base of the balloon 11 is a receiver 19, which houses an illumination means, and a quick connect valve 23 for filling the balloon 11.

The kit further includes a reel 12 containing a tethering string 13 therein. The reel 12 is a cylindrical device that includes a cover with a tethering string aperture 16, an internal spool, and a handle 17. The reel 12 resembles a conventional fishing rod reel, and is designed to be handheld when in use. The tethering string 13 can be threaded through the tethering string aperture 16, and the device can be set to allow for release of the tethering string 13, which can then be secured to the D-ring 54.

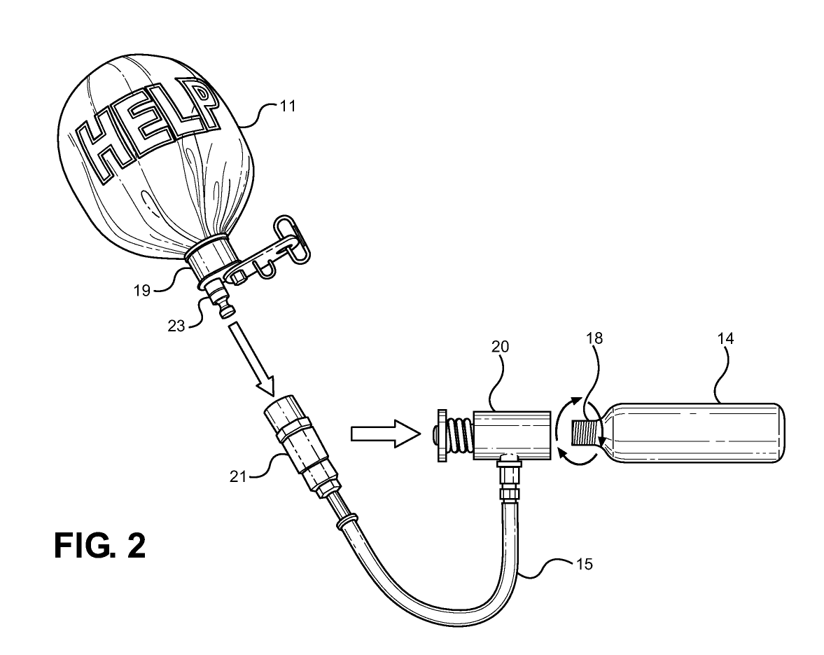

Referring now to FIG. 2, there is shown a view of the tank 14, balloon filling adapter 15 and balloon filling receiver 19 filling the balloon 11 with a lighter-than-air gas. The present invention utilizes a tank 14 for filling of the balloon 11. Preferably, the tank 14 is a conventional tank that is well understood in the art, and is designed to hold a lighter-than-air gas. The tank 14 preferably includes a sufficient amount of gas to fill the balloon 11 multiple times. The filling end 18 of the tank 14 is threaded to enable attachment thereof to the filling adapter 15. A user can thread the filling end 18 to the adapter 15 for use. The tank 14 can be filled with a variety of lighter-than-air gases, preferably helium. This enables the balloon 11 to rise to a height for improved visibility.

The adapter 15 provides a means of connecting the balloon 11 with the tank 14. The adapter 15 enables the lighter-than-air gas to be transferred from the tank 14 to the balloon 11. In the preferred embodiment, the adapter 15 comprises a first end having a conventional spring-loaded puncture valve 20 to allow the gas to transfer from the tank 14 and through the valve 20. As the user depresses the valve 20, the gas, which is stored under pressure in the tank 14, travels through the valve 20 towards the balloon 11.

The adapter 15 additionally includes a second end comprising a check valve 21. The valve 21 is used to provide a fast connection for gas transfer between the tank 14 and balloon 11. This replaces a conventional threaded attachment means which would otherwise require a wrench. The check valve 21 attaches to a male quick connect fitting 23 on the receiver 19. The receiver 19 is comprised of an annular housing that is attached to the base of the balloon 11. The receiver 19 provides a means of filling the balloon 11 through the quick connect fitting 23, and prevents the need for tying the balloon 11 after filling with gas. The gas is forced through the quick connect fitting 23 in the receiver 19 and into the balloon 11, which causes the balloon 11 to expand in size.

In operation, a user threads the filling end 18 of the tank 14 into the spring-loaded puncture valve 20 end of the adapter 15. The user then attaches the check valve 21 to the quick connect fitting 23 on the receiver 19. To inflate the balloon 11, the user depresses the puncture valve 20, which allows the gas contained within the tank 14 to flow through the adapter 15 and into the balloon 11. The balloon 11 is filled with a sufficient amount of lighter-than-air gas to float the attached receiver and tethering string. Once a sufficient amount of gas has been transferred into the balloon 11, the user can release the puncture valve 20, and detach the receiver 19 from the check valve 21.

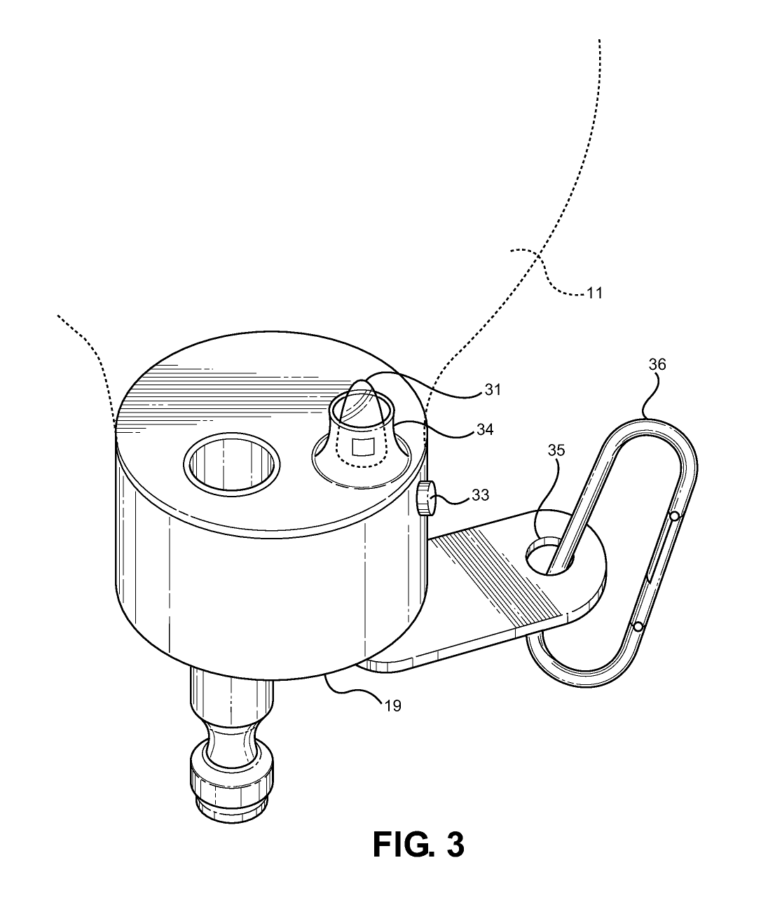

The balloon 11 further includes an illumination means. In the preferred embodiment, the illumination means comprises a light source, such as a light emitting diode (“LED”) for increasing visibility in lowlight or dark conditions. As shown in FIG. 3, the LED 31 is conventionally disposed within the receiver 19 and is conventionally connected to a power source. A power switch 33 is also disposed on the receiver 19. When depressed, the power switch 33 completes a circuit for illuminating the LED 31. In addition, the receiver 19 further includes a reflector 34 that surrounds the LED 31, which is used to diffuse the light emitted by the LED 31 to illuminate the entire balloon 11.

The receiver 19 further includes a means of attaching the tethering string thereto. In the preferred embodiment, the attachment means comprises a conventional carabineer 36 that secures to an aperture 35 on the receiver 19. The carabineer 36 is a metal loop with a sprung gate used to quickly and reversibly connect the balloon and tethering string.

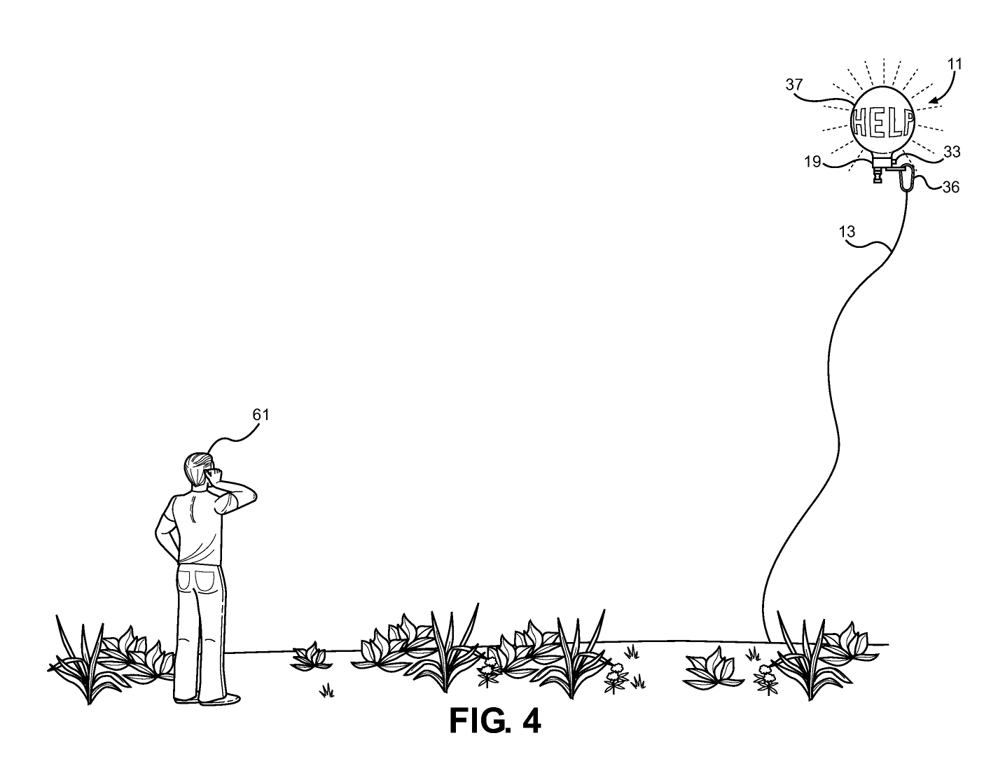

Referring now to FIG. 4, there is shown a pictorial view of the present invention in use, with the balloon 11 in an inflated state, and the illumination means activated. In operation, if a person is lost or injured, he or she can inflate the balloon 11 and allow it to rise for viewing by a rescuer 61. A user can open the case, inflate the balloon 11, attach the tethering string 13 to the carabineer 36 on the receiver 19, and release the tethering string 13 from within the reel. Once a sufficient amount of string 13 has been released to enable the balloon 11 to float at a desired height, the string 13 can be anchored to the case.

The balloon 11 is preferably of a color that will indicate the need for emergency help, such as bright yellow or orange. In order to ensure that a rescuer 61 understands that the balloon 11 signifies that a user is in need of assistance, the balloon further contains indicia 37 thereon that comprises a message, such as “HELP.” If the device is to be used at night, the user can activate the illumination means. The user can depress the power switch 33 on the exterior of the receiver 19, which causes the LED to illuminate. Because the LED is housed on the interior of the balloon 11, it causes the entire balloon 11 to illuminate for improved visibility. To increase visibility, the indicia 37 are outlined with a dark color to provide additional contrast for viewing at night.

Overall, the present invention provides a device that makes the location of the lost or injured person more conspicuous, which facilitates quicker rescue. The device can be inflated and floated up to a sufficient height for viewing at a distance. The illumination means enables the device to be viewed in lowlight or dark conditions, thereby increasing the possibility of rescue after sunset. Because the device is self contained, it can be used by an injured person with limited mobility. Once the device is deployed, it can be used to locate the position of the lost person, even if injured and unconscious. In this way, the present invention provides a rescue tool that allows a rescuer to quickly determine the exact location of the lost or injured person.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An emergency notification balloon, comprising:
an inflatable balloon with an attached receiver;
a reel containing a tethering string;
a tank containing a lighter-than-air gas for filling said balloon;
and a balloon filling adapter for attaching to said balloon filling receiver.

2) The device of claim 1, further comprising a storage case comprising a carrying handle, a strap that secures around said case, and an attachment means for securing said tethering string thereto.

3) The device of claim 2, wherein said attachment means comprises a D-ring.

4) The device of claim 1, wherein said balloon comprises an inflatable, flexible bag for holding a lighter-than-air gas, which provides said balloon with a sufficient amount of buoyancy to float.

5) The device of claim 1, wherein said balloon receiver includes an illumination means and a quick connect valve.

6) The device of claim 1, wherein said reel includes a cover with a tethering string aperture, an internal spool, and a handle.

7) The device of claim 1, wherein said tank includes a filling end containing threading to enable attachment of said tank to said filling adapter.

8) The device of claim 1, wherein said balloon filling adapter includes a first end having a conventional spring-loaded puncture valve and a second end including a check valve.

9) A method of filling a balloon with a lighter-than-air gas comprising the steps of:
threading the filling end of said tank into said spring-loaded puncture valve on said adapter;
attaching said check valve to said quick connect fitting on said receiver; and
depressing said spring to allow the gas contained within said tank to flow through said adapter and into said balloon until said balloon is filled with a sufficient amount of lighter-than-air gas to achieve buoyancy.

10) The device of claim 1, wherein said attached receiver includes an illumination means.

11) The device of claim 10, wherein said illumination means comprises a light source that is conventionally disposed on the top surface of said receiver and is conventionally connected to a power source.

12) The device of claim 10, wherein said light source comprises a light emitting diode.

13) The device of claim 1, wherein said receiver includes a power switch for activating said illumination means.

14) The device of claim 1, wherein said receiver includes an aperture for accepting an attachment means for said tethering string.

15) The device of claim 14, wherein said attachment means comprises a metal loop with a sprung gate.

16) The device of claim 1, wherein said balloon is constructed in a bright color that indicates the need for emergency help.

17) The device of claim 1, wherein said balloon includes indicia thereon that indicates the need for emergency help.

18) The device of claim 17, wherein said indicia are outlined with a dark color to provide additional contrast for viewing at night.
